(19) United States
(12) Patent Application Publication
(10) Pub. No.: US 2014/0282564 A1
(43) Pub. Date: Sep. 18, 2014

(54) THREAD-SUSPENDING EXECUTION BARRIER

(71) Applicants: Eli Almog, Austin, TX (US); Michele W. Adkins, Austin, TX (US); Peter J. Wilson, Leander, TX (US)

(72) Inventors: Eli Almog, Austin, TX (US); Michele W. Adkins, Austin, TX (US); Peter J. Wilson, Leander, TX (US)

(21) Appl. No.: 13/843,179

(22) Filed: Mar. 15, 2013

(51) Int. Cl. G06F 9/46

(52) U.S. Cl. CPC G06F 9/46
USPC 718/102

(57) ABSTRACT

An energy-efficient execution barrier for parallel processing is provided. The execution barrier associates a thread-execution bit with each hardware-supported thread. The energy-efficient execution barrier utilizes a per-processor or per-chip bit vector register, having, for example, one bit per possible thread. A bit enables or disables the execution of its corresponding thread. A process starts by forking threads and enabling them in the bit vector register. When a thread arrives at the barrier/rendezvous, the thread disables its own bit and therefore suspends thread execution. When a distinguished thread arrives at the barrier, it waits (e.g., spinlocks) until all the threads needed for the rendezvous are disabled. The distinguished thread (or an automatic thread re-enable mechanism) then atomically sets all threads bits in the bit vector register to enabled, and the threads perform any appropriate sync operations and continue.

### BACKGROUND

### Field of the Disclosure

The present disclosure relates generally to parallel computing and, more particularly, to execution barriers.

When software running as multiple processing threads on multiple cores (on a single chip or on multiple chips) needs to have one core update a value and multiple cores see the updated value, there must be some synchronization between the cores. This can be accomplished using a synchronization barrier (barrier) operation, which causes each core involved to wait at a barrier to further execution until all cores have arrived at the barrier and then continue together. In many computer architectures, a barrier is implemented using cache-coherent shared memory and some form of shared data structure—one example is to have a counter initialized to zero, and, upon reaching the barrier, each thread, regardless of which of the multiple cores is executing it, atomically increments the counter and performs a spinlock, e.g., waits and increments a counter each time a thread of one of the other cores reaches the barrier, waiting in the spinlock until the counter's value is equal to the number of threads which need to rendezvous, whereupon every thread executes an appropriate sync operation, as needed, and all threads continue execution. (Note that atomic instructions are instructions the processing of which occurs as a contiguous sequence of events that cannot be interrupted, for example, by interrupts, multithreading, other processor cores, or the like.)

This is an energy-expensive way to create a barrier, as each core needs to fetch and execute instructions in the spinlock loop, read the counter, and generate cache coherence traffic to notify each core of its spinlock state.

### BRIEF DESCRIPTION OF THE DRAWINGS

The present disclosure may be better understood, and its numerous features and advantages made apparent to those skilled in the art by referencing the accompanying drawings.

FIG. 1 is a block diagram illustrating a parallel computer system providing a thread-suspending execution barrier in accordance with at least one embodiment.

FIG. 2 is a block diagram illustrating a processor providing a thread-suspending execution barrier in accordance with at least one embodiment.

FIG. 3 is a flow diagram illustrating a method for providing a thread-suspending execution barrier in accordance with at least one embodiment.

FIG. 4 is a block diagram illustrating a processor comprising an auto thread re-enable mechanism for providing a thread-suspending execution barrier based on a distinguished thread in accordance with at least one embodiment.

FIG. 5 is a flow diagram illustrating a method for providing a thread-suspending execution barrier utilizing an auto thread re-enable mechanism in accordance with at least one embodiment.

FIG. 6 is a block diagram illustrating a processor comprising an auto thread re-enable mechanism for providing a thread-suspending execution barrier in accordance with at least one embodiment.

FIG. 7 is a block diagram illustrating a multi-core computer system providing a thread-suspending execution barrier in accordance with at least one embodiment.

FIG. 8 is a block diagram illustrating apparatus for providing a chained, two-level execution barrier in accordance with at least one embodiment.

FIG. 9 is a flow diagram illustrating a method for providing a chained, two-level execution barrier in accordance with at least one embodiment.

The use of the same reference symbols in different drawings indicates similar or identical items.

### DETAILED DESCRIPTION OF THE DRAWINGS

A thread-suspending execution barrier is described. In accordance with one embodiment, an apparatus comprises a processing structure enabling parallel execution of a plurality of threads, a bit vector register (or, simply, bit register), and a thread re-enablement entity. Such parallel execution may include execution wherein a processor switches in time between execution of at least a portion of the plurality of threads, such that the processor need not be executing instructions of more than one thread at any particular moment in time, but, over several switches in time between execution of the threads, advances execution of the at least the portion of the plurality of threads. Such parallel execution may include execution wherein multiple threads are being executed at the same moment in time, for example, on difference processor cores. Parallel execution may include combinations of the foregoing and the like. The bit vector register comprises a corresponding bit location for each of the plurality of threads. Each of the plurality of threads can cause its corresponding bit of the bit vector register to be changed from a first state to a second state to indicate its arrival at a barrier. The execution of program code of each of the plurality of threads is suspended when its corresponding bit is in the second state, which indicates it has arrived at a barrier. A thread re-enablement entity changes the corresponding bits for the plurality of bits from the second state to the first state to re-enable execution of program code of the plurality of threads.

At least one embodiment provides an execution barrier between the cores of a multicore processing system that uses less energy than traditional synchronization barrier schemes. The energy-efficient execution barrier associates a thread-execution bit with each hardware-supported thread (e.g., with each thread, regardless of which processor core executes it, or, as another example, with each core executing at least one thread subject to the execution barrier). Rather than using in-memory data structures, the energy-efficient execution barrier utilizes a per-processor or per-chip bit vector, having, for example, one bit per possible thread, or, as other examples, one bit per core or one bit per core executing at least one thread subject to the execution barrier. A bit enables or disables the execution of program code of its corresponding thread based upon its logic state. Another aspect of a particular embodiment implements new instructions to allow atomic setting and clearing of individual bits.

A process starts by forking threads, e.g., configuring the program code to be executed as a plurality of threads, wherein such plurality of threads need not be executed by a single processor core, but rather the execution of the program code may be distributed among multiple processor cores by assigning different threads to be executed on different processor cores, and enabling the threads in the bit vector. When a thread arrives at the barrier/rendezvous, the thread disables its own bit to indicate it has stopped execution of the program code of that thread. A specific thread, referred to herein as a distinguished thread, performs a supervisory operation to wait and monitor whether all other threads have arrived at the barrier, e.g., the distinguished thread can implement a spinlock. Upon each thread reaching the barrier, a supervisory operation of the distinguished thread (or an automatic thread re-enable mechanism) then atomically sets all threads bits to enabled, and the threads perform any appropriate sync operations and continue. In a variation, the distinguished thread performs a supervisory operation to enable a controller, such as a hardware circuit (e.g., the automatic thread re-enable mechanism), when all relevant, e.g., unmasked, enable bits are zero, and disables itself (e.g., disables not only the execution of its program code but also active performance of a supervisory operation for waiting, such as spinlocking). By enabling the re-enable mechanism, and shutting itself down, the distinguished thread avoids the spinlock energy dissipation of the distinguished thread. Note that the early described embodiment, where one of the threads remains in a spinlock to monitor the other threads, also provides significant energy savings as compared to spinlock energy dissipation of all of the threads arriving at the execution barrier. The bit vector may contain many more bits than the number of threads that need to recognize a particular barrier and can be addressed via a form of memory management unit (MMU) to allow efficient, safe creation of barriers for multiple processes.

A lock is a synchronization mechanism in an information processing system for enforcing limits on access to a resource in a multi-threaded processing environment. A thread is a small sequence of instruction code that can be managed by an operating system scheduler. A multi-threaded processing environment allows execution of multiple threads at or near the same time (e.g., in a time-division-multiplexed manner interleaved in time among each other, for example, within a single processor core, or at the same time among multiple processor cores). A spinlock is a type of lock which causes a thread trying to acquire it (e.g., to be able to proceed) to wait (e.g., in a loop) until the lock is available. The thread may repeatedly check if the lock is available to be acquired by the thread. The supervisory instruction code (or other supervisory mechanism) associated with the thread may remain active as it performs the spinlock loop waiting to acquire the lock, but the application program instruction code (e.g., program code) associated with the thread may have its execution suspended until the supervisory instruction code (or other supervisory mechanism) acquires the lock and allows the execution of the application program instruction code to proceed.

An execution barrier between separate clusters (e.g., chips, multithreaded cores on a single chip, etc.) that do not share a commonly accessible bit vector register may be provided using classic methods while the execution barrier between threads executed on a processor core or processor cores that can access a bit vector register may be implemented as described above. The distinguished thread in each cluster performs classic barrier operations with the other distinguished threads of the other clusters even as the distinguished thread in each cluster may perform the technique described above to implement the execution barrier with respect to the non-distinguished threads of its own cluster.

A bit vector register, the Thread Enable Status Register (TENSR), is provided, wherein each bit of the TENSR corresponds to a different thread, wherein the threads need not be executed by the same processor core. The TENSR is a shared resource that is accessible by each individual thread and by a common thread re-enablement entity, which itself may be a thread (distinguished thread). Processor instructions are also implemented to allow the atomic setting and clearing of individual bits in the TENSR. In accordance with at least one embodiment, new hardware (e.g., an automatic thread re-enable mechanism) is provided to enable or disable the execution of a thread according to the state of its corresponding TENSR bit. By coupling thread-execution enable bits with the ability to set and clear the bits in response to thread arrival at an execution barrier, an energy-efficient execution barrier is provided. Such an energy-efficient execution barrier may be used to facilitate energy-efficient multicore processing operation. Such an energy-efficient execution barrier may be implemented, for example, in multithreaded processing architectures, in multicore processing architectures, in system-on-a-chip (SoC) architectures, in microcontrollers (MCUs), in microprocessor units (MPUs), in processing architectures intended for low power operation, etc.

FIG. 1 is a block diagram illustrating a parallel-processing computer system (a parallel computer system) providing a thread-suspending execution barrier in accordance with at least one embodiment. The parallel computer system 100 of FIG. 1 comprises a processor 101, one or more modules 102, 103, 104, a direct memory access (DMA) interface 105, memory 106, an input-output (I/O) interface 107, peripherals 108, and a bus 109 connecting the foregoing elements. Processor 101 is connected to bus 109 via connection 110 and comprises a processing structure 118 and shared resources 119. Processing structure 118 is capable of processing a plurality of threads 121, 122, 123, and 124 in parallel. Processing structure 118 has one or more processing cores. As an example, processing structure 118 may be a multi-threaded single-core processor. As another example, processing structure 118 may be a multi-core processor. Shared resources 119 comprise a thread enable status register (TENSR) 120. TENSR 120 stores a plurality of bits wherein a bit enables and disables execution of corresponding thread of the plurality of threads 121-124. Control of the bits of TENSR 120 by threads 121-124 and the dependency of the execution of threads 121-124 are illustrated by connections 125, 126, 127, and 128 between threads 121-124, respectively, and the corresponding bits of TENSR 120.

One or more modules 102, 103, and 104 may provide similar or different types of functionality to computer system 100 as processor 101. As an example, one or more modules 102, 103, and 104 may comprise additional processors, similar to or different from processor 101. Such additional processors may be on the same semiconductor die as processor 101 or on one or more different semiconductor dice. As another example, one or more modules 102, 103, and 104 may comprise co-processors, such as arithmetic processors, graphics processors, or digital signal processors, or subsystems, such as network interface subsystems, wireless communications subsystems, power management subsystems, the like, or combinations thereof. One or more modules 102, 103, and 104 are connected to bus 109 via connections 111, 112, and 113, respectively.

Direct memory access (DMA) interface 105 is connected to bus 109 via connection 114. Memory 106 is connected to bus 109 via connection 115. Input-output (I/O) interface 107 is connected to bus 109 via connection 116. Peripherals 108 are connected to bus 109 via connection 117.

FIG. 2 is a block diagram illustrating a processor providing a thread-suspending execution barrier in accordance with at least one embodiment. The processor is an example of a processor 101 of computer system 101 wherein thread 121 is a distinguished thread, e.g., monitors the other threads, and therefore has a different (distinguished) operation. Threads 121-124 represent threads labeled thread 1 through thread n, respectively. Processor core 101 comprises processing structure 118, which may execute threads 121-124. In shared resources 119, the TENSR is illustrated as individual TENSR bits 241, 242, 243, and 244 which correspond to each thread as a TENSR bit 1, a TENSR bit 2, one or more intervening TENSR bits, and an nth TENSR bit, respectively.

As a distinguished thread, thread 121 is able to change a state of its own TENSR bit 241, for example to clear its own TENSR bit 241 upon arriving at an execution barrier, to set its own TENSR bit 241 when execution is to continue from the execution barrier, as illustrated by connection 225 from thread 121 to TENSR bit 241, and to change a state of the TENSR bits 242-244 of other threads 122-124 to which the execution barrier pertains, as illustrated by connections 235-237, respectively. As a distinguished thread, thread 121 is also configured to read the values of all TENSR bits corresponding to the threads to which the execution barrier pertains. Thread 121 is able to respond to a state of its own TENSR bit 241, as illustrated by connection 231.

As non-distinguished threads, threads 122-124 are able to change the states of their corresponding TENSR bits 242-244, respectively, for example, to clear their corresponding TENSR bits 242-244 upon arrival at the execution barrier, as illustrated by connections 226-228, respectively. Threads 122-124 are able to respond to a state of their own TENSR bits 242-244, respectively, for example, by suspending or continuing execution dependent on the state of their TENSR bits 242-244, respectively, as illustrated by connections 232-234, respectively.

FIG. 3 is a flow diagram illustrating a method for providing a thread-suspending execution barrier in accordance with at least one embodiment. The method begins at block 301. From block 301, the method continues to block 302. In block 302, a counter is initialized, for example, to a value of zero. In block 303, a process forks n threads, e.g., generates n threads, with a thread n illustrated along a left column, with a thread 1 illustrated along a right column, and with other intervening threads represented by arrows 308 between the left column and the right column. Such a process may be a sequence of processing blocks that are to be performed in accordance with a quantity of program code that is amenable to parallel processing, so the process that is to be performed may be distributed into threads which may be executed in parallel by one or more processor cores to perform the process. To coordinate execution of the threads of a process, which may require accommodating logical dependencies between the threads of the process, an execution barrier may suspend thread execution among the threads of the process as each thread encounters an instruction enforcing the execution barrier. For purposes of discussion, thread 1 is presumed to be a distinguished thread, and threads 2-n are not distinguished, e.g., the operation of the other intervening threads can be similar to that of thread n, as illustrated in the left column. The threads may perform their corresponding blocks of the method in parallel.

From block 303, thread n continues to block 304, where it executes pre-barrier computations based upon program code of thread n. When thread n reaches the execution barrier, thread n stops executing the program code. From block 304, thread n continues to block 305. In block 305, thread n executes synchronization operations to ensure prior memory operations have completed. From block 305, thread n continues to block 306. In block 306, thread n clears TENSR bit n, which corresponds to thread n. From block 306, thread n continues to block 307. In block 307, thread n suspends execution of its program code until TENSR bit n has a value of one, which can occur after a distinguished thread (e.g., thread 1) sets TENSR bit n to indicate continuation of execution from the execution barrier. The suspension of execution of the program code can maintain the current state of the thread being suspended, maintaining, for example, the state of memory containing program code, data, register values, stacks, pointers, and other information relevant to the thread, yet the suspension may allow reducing or stopping a clock signal of the processing entity which had been executing the suspended thread, reducing a power consumption mode of the processing entity which had been executing the suspended thread, and the like.

From block 303, thread 1 continues to block 309. In block 309, thread 1 executes pre-barrier computations. From block 309, thread 1 continues to block 310. In block 310, thread 1 executes synchronization operations to ensure prior memory operations have completed. From block 310, thread 1 continues to block 311. In block 311, thread 1 clears TENSR bit 1, which corresponds to thread 1. From block 311, thread 1 continues to block 312. In block 312, thread 1 waits until the TENSR logically ANDed with a threadmask, which indicates the threads to which the execution barrier pertains, has a value of zero (i.e., until all threads to which the execution barrier pertains have cleared their corresponding TENSR bits). For example, if the TENSR has a binary value of 01010101 and the threadmask has a binary value of 00001111, indicating the four least significant bits of the TENSR represent threads to which the execution barrier pertains, logically ANDing the TENSR with the threadmask yields the binary value 00000101, which is not zero. Therefore, in accordance with such an example, thread 1 waits at block 312 until the TENSR has a binary value of, for example, 01010000, which, when logically ANDed with the threadmask having the binary value of 00001111, yields the binary value 00000000, which is zero. From block 312, thread 1 continues to block 313. In block 313, a supervisory operation of thread 1 sets the TENSR to be equal to the value of the TENSR logically ORed with the value of the threadmask. In accordance with the example discussed above, logically ORing a TENSR having a binary value of 01010000 with a threadmask having a binary value of 00001111 yields the binary value 01011111, which may be stored in the TENSR to set the bits of the TENSR corresponding to the threads to which the execution barrier pertains while leaving undisturbed the bits of the TENSR corresponding to threads to which the execution barrier does not pertain. From block 313, thread 1 continues to block 314 and thread n continues to block 316. Blocks 314 and 315 for thread 1 occur in response to TENSR bit 1 having been set in block 313. Blocks 316 and 317 for thread n occur in response to TENSR bit n having been set in block 313. In block 314, thread 1 executes operations related to resuming normal operation, e.g., synchronization (e.g., SYNC, ISYNC, etc.) as appropriate. In block 316, thread n executes operations related to resuming normal operation, synchronization (e.g., SYNC, ISYNC, etc.) as appropriate. From block 314, thread 1 continues to block 315. From block 316, thread n continues to block 317. In block 315, thread 1 continues computations. In block 317, thread n continues computations.

While thread 1 is described above as the distinguished thread, no a priori knowledge of the order in which the threads will reach the execution barrier is needed. Accordingly, a thread selected to be the distinguished thread may reach the execution barrier before all other threads, after some other threads but before still other threads, or after all other threads. If the distinguished thread (e.g., thread 1) reaches the execution barrier before some or all of other threads, it waits at block 312 until all other threads have completed their corresponding block 306, at which time all of the TENSR bits will be cleared (i.e., zero). If the distinguished thread has already reached the execution barrier and has already completed its block 311, its TENSR bit will also have been cleared (i.e., zero). Thus, the condition of TENSR ANDed with threadmask being equal to zero of block 312 will be satisfied, and thread 1 can continue from block 312 to block 313.

If the distinguished thread (e.g., thread 1) reaches the execution barrier after all other (i.e., non-distinguished) threads, all of the other threads would have already performed their blocks equivalent to block 306, so all of the bits of the TENSR selected by the threadmask except for the TENSR bit corresponding to the distinguished thread would have already been cleared (i.e., zero). Thus, when the distinguished thread clears its TENSR bit in block 311, all of the TENSR bits selected by the threadmask would be zero, so the condition of TENSR ANDed with threadmask being equal to zero of block 312 would be satisfied, and thread 1 can continue from block 312 to block 313.

In accordance with at least one embodiment, the distinguished thread need not clear its own TENSR bit in block 311 if the condition of block 312 is modified to exclude the TENSR bit corresponding to the distinguished thread. As an example, the threadmask may be modified to set the threadmask bit corresponding to the distinguished thread to zero. As another example, the condition of block 312 may be modified by ANDing the TENSR AND the threadmask with a value having a zero in the bit position corresponding to the distinguished thread and ones in all other bit positions (or at least all other bit positions corresponding to all other threads selected by the threadmask).

FIG. 4 is a block diagram illustrating an alternate embodiment of a processor comprising an auto thread re-enable mechanism for providing a thread-suspending execution barrier based on a distinguished thread. Reference numerals between similar features of FIG. 2 and FIG. 4 have been maintained, where the processor is an example of a processor 101 of computer system 101 and thread 121 is a distinguished thread.

In the embodiment illustrated in FIG. 4, processor 101 comprises an auto thread re-enable mechanism 451 in addition to processing structure 118 and shared resources 119. Auto thread re-enable mechanism 451 can be activated, e.g., enabled, by an activate mechanism 452 accessible to the distinguished thread (e.g., thread 121). For example, activate mechanism 452 may be an activate mechanism command executable by the distinguished thread, an activate mechanism flag settable by the distinguished thread, an activate mechanism register writeable by the distinguished thread, the like, or a combination thereof. The activate mechanism 452 is in communication with the auto thread re-enable mechanism 451, as illustrated by connection 453.

Auto thread re-enable mechanism 451 is connected to the TENSR, allowing it to read the states of TENSR bits 241-244, as illustrated by connections 454-457, respectively, and to modify the states of TENSR bits 241-244, as illustrated by connections 458-461, respectively. Thus, auto thread re-enable mechanism 451 can detect when the states of all of TENSR bits 241-244 (e.g., all of the TENSR bits corresponding to threads to which the execution barrier pertains) have been cleared (e.g., zeroed). Upon detecting such a situation, auto thread re-enable mechanism 451 can set (e.g., write ones to) all of the TENSR bits 241-244 (e.g., all of the TENSR bits corresponding to threads to which the execution barrier pertains) to automatically re-enable execution of the suspended threads after they have all reached the execution barrier.

In accordance with at least one embodiment, the activate mechanism 452 may be implicit, allowing auto thread re-enable mechanism 451 to remain active continuously, as running threads would have their corresponding TENSR bits set, so auto thread re-enable mechanism 451 would not have to intervene except when all relevant threads have had their execution suspended at an execution barrier and their corresponding TENSR bits cleared. A reset mechanism may be provided for the TENSR so that TENSR bits power up in a set state. Even if activate mechanism 452 is not explicitly provided, a mechanism similar to activate mechanism 452 may be provided to at least pass identification (e.g., a threadmask) of which threads are subject to the execution barrier.

In accordance with at least one embodiment, thread 121 may be able to set its own TENSR bit 241 when execution is to continue from the execution barrier, as illustrated by connection 225 from thread 121 to TENSR bit 241, for example if auto thread re-enable mechanism 451 is configured to direct thread 121, as a distinguished thread, to set the TENSR bits corresponding to the threads subject to the execution barrier in response to the auto thread re-enable mechanism 451 detecting the TENSR bits of all of the threads subject to the execution barrier having been cleared. In accordance with such an at least one embodiment, as a distinguished thread, thread 121 is also able to change a state of the TENSR bits 242-244 of other threads 122, 123, and 124 to which the execution barrier pertains, as illustrated by connections 235, 236, and 237, respectively.

FIG. 5 is a flow diagram illustrating a method for providing a thread-suspending execution barrier utilizing an auto thread re-enable mechanism in accordance with at least one embodiment. The method begins in block 501, where a thread executes pre-barrier computations. From block 501, the method continues to block 502. In block 502, the thread executes synchronization operations to ensure prior memory operations have completed. For example, the synchronization operations can communicate to each thread a corresponding barrier condition, e.g., an address location that is not to be executed. From block 502, the method continues to block 503. In block 503, the thread activates an auto thread re-enable mechanism. From block 503, the method continues to block 504. In block 504, the thread clears its corresponding TENSR bit. From block 504, the method continues to block 505. In block 505, the thread suspends its execution in response to its TENSR bit having been cleared. From block 505, the method continues to block 506. In block 506, the auto thread re-enable mechanism performs its function, as the execution of the thread has been suspended. Block 506 can comprise block 507 and block 508. In block 507, the auto thread re-enable mechanism detects when all threads subject to the execution barrier have reached the thread barrier (e.g., by detecting when the TENSR ANDed with a threadmask is equal to zero). From block 507, the method continues to block 508. In block 508, the auto thread re-enable mechanism re-enables execution of all threads subject to the execution barrier (e.g., by setting the TENSR equal to the TENSR ORed with the threadmask). From block 506, the method continues to block 509. In block 509, the thread executes synchronization operations (e.g., SYNC, ISYNC, etc.) as appropriate to assure its synchronization with other relevant threads in the parallel processing environment. From block 509, the method continues to block 510. In block 510, the thread continues computations beyond the execution barrier.

FIG. 6 is a block diagram illustrating an alternate embodiment of a processor comprising an auto thread re-enable mechanism for providing a thread-suspending execution barrier. Reference numerals between similar features of FIG. 2 and FIG. 4 have been maintained, where the processor is an example of a processor 101 of computer system 101 wherein no thread needs to be distinguished thread or to operate in a manner different from other threads. In the embodiment illustrated in FIG. 6, processor 101 comprises an auto thread re-enable mechanism 451 in addition to processing structure 118 and shared resources 119. Auto thread re-enable mechanism 451 can be activated by an activate mechanism 452 accessible to thread 121, by an activate mechanism 662 accessible to thread 122, by an activate mechanism 663 accessible to thread 123, and by an activate mechanism 664 accessible to thread 124. For example, an activate mechanism 452, 662, 663, or 664 may be an activate mechanism command executable by the distinguished thread, an activate mechanism flag settable by the distinguished thread, an activate mechanism register writeable by the distinguished thread, the like, or a combination thereof. The activate mechanism 452 is in communication with the auto thread re-enable mechanism 451, as illustrated by connection 453. The activate mechanism 662 is in communication with the auto thread re-enable mechanism 451, as illustrated by connection 665. The activate mechanism 663 is in communication with the auto thread re-enable mechanism 451, as illustrated by connection 666. The activate mechanism 664 is in communication with the auto thread re-enable mechanism 451, as illustrated by connection 667.

Threads 121-124 may utilize their corresponding activate mechanisms 452, 662, 663, and 664 to activate auto thread re-enable mechanism 451 as part of the process threads 121-124 perform upon reaching the execution barrier. If one thread of threads 121-124 reaches the execution barrier before the other threads, it may utilize its corresponding activate mechanism of activate mechanisms 452, 662, 663, and 664 before the other threads utilize their corresponding activate mechanisms. If one thread of threads 121-124 reaches the execution barrier after the other threads, it may utilize its corresponding activate mechanism of activate mechanisms 452, 662, 663, and 664 after the other threads utilize their corresponding activate mechanisms, although such later utilization of an activate mechanism may be redundant and simply reaffirm the activation of the auto thread re-enable mechanism 451 without necessarily causing any further activation of auto thread re-enable mechanism 451.

Auto thread re-enable mechanism 451 is connected to the TENSR, allowing it to read the states of TENSR bits 241-244, as illustrated by connections 454, 455, 456, and 457, and to modify the states of TENSR bits 241-244, as illustrated by connections 458, 459, 460, and 461. Thus, auto thread re-enable mechanism 451 can detect when the states of all of TENSR bits 241-244 (e.g., all of the TENSR bits corresponding to threads to which the execution barrier pertains) have been cleared (e.g., zeroed). Upon detecting such a situation, auto thread re-enable mechanism 451 can set (e.g., write ones to) all of the TENSR bits 241-244 (e.g., all of the TENSR bits corresponding to threads to which the execution barrier pertains) to automatically re-enable execution of the suspended threads after they have all reached the execution barrier.

In accordance with at least one embodiment, the activate mechanism 452 may be implicit, allowing auto thread re-enable mechanism 451 to remain active continuously, as running threads would have their corresponding TENSR bits set, so auto thread re-enable mechanism 451 would not have to intervene except when all relevant threads have had their execution suspended at an execution barrier and their corresponding TENSR bits cleared. A reset mechanism may be provided for the TENSR so that TENSR bits power up in a set state. Even if activate mechanism 452 is not explicitly provided, a mechanism similar to activate mechanism 452 may be provided to at least pass identification (e.g., a threadmask) of which threads are subject to the execution barrier.

FIG. 7 is a block diagram illustrating a multi-core computer system providing a thread-suspending execution barrier in accordance with at least one embodiment, where a barrier can be set that affects a plurality of processors. The parallel computer system 700 of FIG. 7 comprises a plurality of processors 101, 702, 703, and 704, a direct memory access (DMA) interface 105, memory 106, an input-output (I/O) interface 107, peripherals 108, and a bus 109 connecting the foregoing elements. Processor 101 is connected to bus 109 via connection 110 and comprises a processing structure 118 and shared resources 119. Processing structure 118 is capable of processing a plurality of threads 121-124 in parallel. Shared resources 119 comprise a thread enable status register (TENSR) 120. TENSR 120 stores a plurality of bits wherein a bit enables and disables execution of corresponding thread of the plurality of threads 121-124. Processor 702 is connected to bus 109 via connection 111 and comprises a processing structure 776 and shared resources 777. Processing structure 776 is capable of processing a plurality of threads 786, 787, 788, and 789 in parallel. Shared resources 784 comprise a thread enable status register (TENSR) 785. TENSR 785 stores a plurality of bits wherein a bit enables and disables execution of corresponding thread of the plurality of threads 786, 787, 788, and 789. Processor 703 is connected to bus 109 via connection 112 and comprises a processing structure 783 and shared resources 784. Processing structure 783 is capable of processing a plurality of threads 786, 787, 788, and 789 in parallel. Shared resources 784 comprise a thread enable status register (TENSR) 785. TENSR 785 stores a plurality of bits wherein a bit enables and disables execution of corresponding thread of the plurality of threads 786, 787, 788, and 789. Processor 704 is connected to bus 109 via connection 113 and comprises a processing structure 790 and shared resources 791. Processing structure 790 is capable of processing a plurality of threads 793, 794, 795, and 796 in parallel. Shared resources 791 comprise a thread enable status register (TENSR) 792. TENSR 792 stores a plurality of bits wherein a bit enables and disables execution of corresponding thread of the plurality of threads 793, 794, 795, and 796.

Direct memory access (DMA) interface 105 is connected to bus 109 via connection 114. Memory 106 is connected to bus 109 via connection 115. Input-output (I/O) interface 107 is connected to bus 109 via connection 116. Peripherals 108 are connected to bus 109 via connection 117. One or more other modules may be coupled to bus 109 to provide similar or different types of functionality to computer system 100. As an example, one or more modules 102, 103, and 104 may comprise co-processors, such as arithmetic processors, graphics processors, or digital signal processors, or subsystems, such as network interface subsystems, wireless communications subsystems, power management subsystems, the like, or combinations thereof.

FIG. 8 is a block diagram illustrating apparatus for providing a chained, two-level execution barrier in accordance with at least one embodiment. Reference numerals between similar features of FIG. 8 and previous figures have been maintained. The apparatus illustrated at FIG. 8 comprises at least two processors, which may be similar to or different from one another. An example of such a processor has an organization of processor 101 as illustrated in FIG. 2. The at least two processors may, for example, implement processor cores 101 and 702 of computer system 700 of FIG. 7. In the example shown in FIG. 8, in processor core 101, thread 121 is a distinguished thread, similar to thread 121 of FIG. 2, although other configurations may be used, which may or may not distinguish a particular thread as a distinguished thread, such as the configurations illustrated in FIGS. 4 and 6.

In the example shown in FIG. 8, in processor core 702, threads 799-782 are presumed to operate in a similar manner as threads 121-124, and have corresponding TENSR bits 841-844. Thus, thread 779 is a distinguished thread, similar to thread 121 of FIG. 2 and threads 780-782 are non-distinguished threads.

While processing core 101 and processing core 702 of FIG. 8 may each implement a corresponding internal TENSR-based thread-suspending execution barrier, as described herein, the multiple processor cores, e.g., processor 701 and 101, need not share a common TENSR register, and instead may utilize a counter 775 connected to each processor core processing a thread subject to a common execution barrier. Each processor core processing a thread subject to a common execution barrier increments the counter 775 upon arriving at the execution barrier, for example, via connections 771 and 772. The processor cores may use reservation-based instructions, such as load word and reserve indexed (lwarx) and store word conditional indexed (stwcx) to avoid contention with other processor cores when incrementing the counter 775. The lwarx and stwcx instructions are primitive processor instructions used to a read-modify-write operation on a memory location. The reservation technique employed by such instructions ensures that no other processing entity will modify the contents of the memory location between the time execution of the lwarx instruction occurs and the time the execution of the stwcx instruction is completed. The reservation technique results in effective atomicity of the read-modify-write operation implemented using the lwarx and stwcx instructions or the like. After incrementing the counter 775, the distinguished thread of each separate processor core executing a thread subject to the execution barrier reads the counter 775, for example via connections 771 and 772, to see if all of the other distinguished threads of all other processor cores executing threads subject to the execution barrier have also incremented the counter. If the counter is found to have a value equal to the number of threads subject to the execution barrier, the distinguished thread of each separate processor executing a thread subject to the execution barrier re-enables all of the threads of its separate processor subject to the execution barrier. The distinguished thread may re-enable the threads itself, for example, by setting the TENSR bits corresponding to the threads, or it may cause another mechanism, such as an auto thread re-enable mechanism, to re-enable the threads. Counter 775 is reset to zero before being incremented by the respective distinguished threads of the separate processors. For example, counter 775 may be reset to zero after execution resumes from the execution barrier so that counter 775 will be ready to be incremented by the distinguished threads of the separate processors upon arrival at the next execution barrier.

In accordance with at least one embodiment, a counter such as counter 775 of FIGS. 7 and 8 may be used fewer than all of processing entities (e.g., by at least one, but fewer than all, of processor cores 101, 702, 703, and 704 of FIG. 7 or processing structures 101 and 702 of FIG. 8. Thus, not all processing entities of a processing system necessarily have to be subject to a common execution barrier even though some subset thereof may be. As an example, an independent process that does not require synchronization with a multi-threaded process subject to a common execution barrier may continue its execution unaffected by the common execution barrier of the multi-threaded process. Such an independent process, for example, may or may comprise multiple threads of its own which may or may not be subject to their own common execution barrier, which may or may not be implemented in accordance with at least one embodiment described herein. Moreover, a processing system implemented with features of at least one embodiment described herein may or may not also be implemented with features of at least one other embodiment described herein. Furthermore, a processing system implemented with features of at least one embodiment described herein may or may not also be implemented with one or more additional instances of the same one or more embodiment or a combination of one or more additional instances of the same one or more embodiment and at least one other embodiment described herein.

FIG. 9 is a flow diagram illustrating a method for providing a chained, two-level execution barrier in accordance with at least one embodiment. The method begins at block 901. From block 901, the method continues to block 902. In block 902, a counter is initialized, for example, to a value of zero. In block 903, a process forks n threads, with a thread n illustrated along a left column, with a thread 1 illustrated along a right column, and with other intervening threads represented by arrows 908 between the left column and the right column. The operation of the other intervening threads can be similar to that of thread n, as illustrated in the left column. The threads may perform their corresponding blocks of the method in parallel.

From block 903, thread n continues to block 904, where it executes pre-barrier computations. From block 904, thread n continues to block 905. In block 905, thread n executes synchronization operations to ensure prior memory operations have completed. From block 905, thread n continues to block 906. In block 906, thread n clears TENSR bit n, which corresponds to thread n. From block 906, thread n continues to block 907. In block 907, thread n suspends its execution until TENSR bit n has a value of one, which can occur after a distinguished thread (e.g., thread 1) sets TENSR bit n to indicate continuation of execution from the execution barrier.

From block 903, thread 1 continues to block 909. In block 909, thread 1 executes pre-barrier computations. From block 909, thread 1 continues to block 910. In block 910, thread 1 executes synchronization operations to ensure prior memory operations have completed. From block 910, thread 1 continues to block 911. In block 911, thread 1 clears TENSR bit 1, which corresponds to thread 1. From block 911, thread 1 continues to block 912. In block 912, thread 1 waits until the TENSR ANDed with a threadmask indicating the threads to which the execution barrier pertains has a value of zero (i.e., until all threads to which the execution barrier pertains have cleared their corresponding TENSR bits). From block 912, thread 1 continues to block 918. In block 918, thread 1 performs a classic barrier protocol with other distinguished threads of other processors that may not have access to common shared resources to be able to implement a common TENSR. From block 918, the method continues to block 913. In block 913, thread 1 sets the TENSR to be equal to the value of the TENSR ORed with the value of the threadmask. From block 913, thread 1 continues to block 914 and thread n continues to block 916. In block 914, thread 1 executes synchronization (e.g., SYNC, ISYNC, etc.) as appropriate. In block 916, thread n executes synchronization (e.g., SYNC, ISYNC, etc.) as appropriate. From block 914, thread 1 continues to block 915. From block 916, thread n continues to block 917. In block 915, thread 1 continues computations. In block 917, thread n continues computations.

In accordance with at least one embodiment, for example, an apparatus shown in FIG. 8 or a method shown in FIG. 9, power savings obtained from implementation of a thread-suspending execution barrier for at least one level of a multi-level parallel processing system can be realized even when structural limitations of the system may prevent a thread-suspending execution barrier to be implemented at every level of the multi-level system. Accordingly, substantial power savings can be obtained over a wide range of system architectures and configurations.

While a distinguished thread, in accordance with at least one embodiment, may perform spinlocking to wait and monitor whether all other threads subject to a common execution barrier have arrived at the barrier, it should be understood that a distinguished thread is not limited to spinlocking. As an example, a distinguished thread may place itself (or be placed by another entity) into a quiescent state (e.g., a sleep mode, a low-power mode, a standby mode, a lower-clock-rate mode, or the like) while waiting and have a mechanism return it to an active state or perform its monitoring for it. For example, a distinguished thread may place itself in a quiescent state and have itself restored to an active state by a hardware interrupt that may occur, for example, in response to a counter reaching a prescribed value, which the distinguished thread may or may not itself prescribe. As an example, a distinguished thread may repeat such operation in concert with checking whether the other threads subject to the execution barrier have arrived at the execution barrier until the other threads subject to the execution barrier have all arrived at the execution barrier. By having the distinguished thread perform the waiting and checking on behalf of the other (i.e., non-distinguished) threads, not only may the distinguished thread save the energy that may otherwise be consumed by the other threads if they had been spinlocking, but also the distinguished thread may make economical use of system resources such as a counter and an interrupt mechanism by minimizing their use (although other embodiments may use more of such system resources, if desired).

While a distinguished thread may serve as a distinguished thread for at least one execution barrier, the same thread may serve as a non-distinguished thread for at least one other execution barrier. While a non-distinguished thread may serve as a non-distinguished thread for at least one execution barrier, the same thread may serve as a distinguished thread for at least one other execution barrier. A distinguished thread may serve as a distinguished thread for more than one execution barrier. A non-distinguished thread may serve as a non-distinguished thread for more than one execution barrier.

In accordance with at least one embodiment, a processing apparatus comprises a processing structure configured to execute program code using a plurality of threads, a bit register including a plurality of bits, wherein during operation each thread being executed by the processing structure corresponds to a bit of the plurality of bits, wherein each of the plurality of threads can change its corresponding bit from a first state to a second state, wherein the execution of the program code of each of the plurality of threads is suspended when its corresponding bit is in the second state, and a thread re-enablement entity for changing the corresponding bits for the plurality of bits from the second state to the first state to re-enable execution of the program code of the plurality of threads. In accordance with at least one embodiment, the thread re-enablement entity is a distinguished thread executed on the processing structure. In accordance with at least one embodiment, the distinguished thread waits for the corresponding bits for each of the plurality of bits to attain the second state before changing the corresponding bits from the second state to the first state. In accordance with at least one embodiment, the program code of the distinguished thread is executed on a first processor core and the distinguished thread interacts with a second distinguished thread of a second processor core. In accordance with at least one embodiment, the thread re-enablement entity is a thread re-enablement mechanism responsive to the corresponding bits for each of the plurality of threads attaining the second state. In accordance with at least one embodiment, the thread re-enablement mechanism comprises digital logic gates. In accordance with at least one embodiment, the apparatus further comprises a thread mask for masking off additional threads, wherein the bit register comprises additional bits respectively corresponding to the additional threads. In accordance with at least one embodiment, execution of additional thread program code of the additional threads occurs independent of binary states of the additional bits of the bit register as a result of the thread mask masking off the additional threads.

In accordance with at least one embodiment, in a processor device, a method comprises executing pre-execution barrier computations based upon program code of a thread, wherein the thread is to stop executing the program code in response to reaching an execution barrier, changing a thread enable status register bit from a first state to a second state upon the thread reaching the execution barrier, suspending program code execution by the thread until the thread enable status register bit returns to the first state, and executing post-barrier computations in response to the thread enable status bit register bit having returned to the first state. In accordance with at least one embodiment, the method further comprises executing pre-barrier synchronization operations to ensure that prior memory operations have completed. In accordance with at least one embodiment, the method further comprises executing post-barrier synchronization operations in response to the thread enable status bit register bit having returned to the first state. In accordance with at least one embodiment, the method further comprises changing at least a second thread enable status register bit from the first state to the second state upon at least a second thread of a plurality of threads reaching the execution barrier, wherein a plurality of thread enable status register bits correspond, respectively, to the plurality of threads, and suspending thread execution of the second program code of the second thread until the second thread enable status register bit returns to the first state, wherein the plurality of thread enable status register bits return to the first state in response to the plurality of thread enable status register bits having been changed from the first state to the second state. In accordance with at least one embodiment, the method further comprises returning, by execution of a supervisory operation of a distinguished thread, the plurality of thread enable status register bits to the first state. In accordance with at least one embodiment, the method further comprises returning, by operation of a thread re-enablement mechanism, the plurality of thread enable status register bits to the first state.

In accordance with at least one embodiment, in a processor device, a method comprises suspending a first execution of first program code of a first thread by entering a quiescent state upon the first execution of the first thread reaching a first execution barrier, suspending a second execution of second program code of a second thread by entering the quiescent state upon the second execution of the second thread reaching a second execution barrier, detecting when the first execution of the first program code of the first thread and the second execution of the second program code of the second thread have been suspended by entering the quiescent state, and re-enabling the first execution of the first program code of the first thread by entering an active state and the second execution of the second program code of the second thread by entering the active state. In accordance with at least one embodiment, the re-enabling comprises re-enabling by a first supervisory operation of a distinguished thread the first execution of the first program code of the first thread by entering the active state and the second execution of the second program code of the second thread by entering the active state. In accordance with at least one embodiment, the detecting comprises detecting by a second supervisory operation of the distinguished thread when the first execution and the second execution have been suspended by entering the quiescent state while the distinguished thread remains in the active state. In accordance with at least one embodiment, the detecting by second supervisory operation of the distinguished thread comprises spinlocking by the second supervisory operation of the distinguished thread while the quiescent state of at least one of the first thread and the second thread prevents the at least one of the first thread and the second thread from spinlocking. In accordance with at least one embodiment, the method further comprises engaging by the distinguished thread in a execution barrier protocol with another distinguished thread of another processor device. In accordance with at least one embodiment, the method further comprises placing the distinguished thread in a low-power state, and restoring the distinguished thread from the low-power state. In accordance with at least one embodiment, the re-enabling comprises re-enabling by a thread re-enablement mechanism the first execution of the first program code of the first thread and the second execution of the second program code of the second thread. In accordance with at least one embodiment, the method further comprises applying a thread mask to specify the first thread and the second thread as being subject to the detecting and re-enabling.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

1. A processing apparatus comprising:
a processing structure configured to execute program code using a plurality of threads;
a bit register including a plurality of bits, wherein during operation each thread being executed by the processing structure corresponds to a bit of the plurality of bits, wherein each of the plurality of threads can change its corresponding bit from a first state to a second state, wherein the execution of the program code of each of the plurality of threads is suspended when its corresponding bit is in the second state; and
a thread re-enablement entity for changing the corresponding bits for the plurality of bits from the second state to the first state to re-enable execution of the program code of the plurality of threads.

2. The processing apparatus of claim 1 wherein the thread re-enablement entity is a distinguished thread executed on the processing structure.

3. The processing apparatus of claim 2 wherein the distinguished thread waits for the corresponding bits for each of the plurality of bits to attain the second state before changing the corresponding bits from the second state to the first state.

4. The processing apparatus of claim 2 wherein the program code of the distinguished thread is executed on a first processor core and the distinguished thread interacts with a second distinguished thread of a second processor core.

5. The processing apparatus of claim 1 wherein the thread re-enablement entity is a thread re-enablement mechanism responsive to the corresponding bits for each of the plurality of threads attaining the second state.

6. The processing apparatus of claim 5 wherein the thread re-enablement mechanism comprises digital logic gates.

7. The processing apparatus of claim 1 further comprising:
a thread mask for masking off additional threads, wherein the bit register comprises additional bits respectively corresponding to the additional threads.

8. (canceled)

9. In a processor device, a method comprising:
executing pre-execution barrier computations based upon program code of a thread, wherein the thread is to stop executing the program code in response to reaching an execution barrier;
changing a thread enable status register bit from a first state to a second state upon the thread reaching the execution barrier;
suspending program code execution by the thread until the thread enable status register bit returns to the first state; and
executing post-barrier computations in response to the thread enable status bit register bit having returned to the first state.

10. The method of claim 9 further comprising:
executing pre-barrier synchronization operations to ensure that prior memory operations have completed.

11. (canceled)

12. The method of claim 9 further comprising:
changing at least a second thread enable status register bit from the first state to the second state upon at least a second thread of a plurality of threads reaching the execution barrier, wherein a plurality of thread enable status register bits correspond, respectively, to the plurality of threads; and
suspending thread execution of the second program code of the second thread until the second thread enable status register bit returns to the first state, wherein the plurality of thread enable status register bits return to the first state in response to the plurality of thread enable status register bits having been changed from the first state to the second state.

13. The method of claim 9 further comprising:
returning, by execution of a supervisory operation of a distinguished thread, the plurality of thread enable status register bits to the first state.

14. The method of claim 9 further comprising:
returning, by operation of a thread re-enablement mechanism, the plurality of thread enable status register bits to the first state.

15. In a processor device, a method comprising:
suspending a first execution of first program code of a first thread by entering a quiescent state upon the first execution of the first thread reaching a first execution barrier;
suspending a second execution of second program code of a second thread by entering the quiescent state upon the second execution of the second thread reaching a second execution barrier;
detecting when the first execution of the first program code of the first thread and the second execution of the second program code of the second thread have been suspended by entering the quiescent state; and
re-enabling the first execution of the first program code of the first thread by entering an active state and the second execution of the second program code of the second thread by entering the active state.

16. The method of claim 15 wherein the re-enabling comprises:
re-enabling by a first supervisory operation of a distinguished thread the first execution of the first program code of the first thread by entering the active state and the second execution of the second program code of the second thread by entering the active state.

17. The method of claim 16 wherein the detecting comprises:
detecting by a second supervisory operation of the distinguished thread when the first execution and the second execution have been suspended by entering the quiescent state while the distinguished thread remains in the active state.

18. The method of claim 17 wherein the detecting by second supervisory operation of the distinguished thread comprises:
spinlocking by the second supervisory operation of the distinguished thread while the quiescent state of at least one of the first thread and the second thread prevents the at least one of the first thread and the second thread from spinlocking.

19. The method of claim 16 further comprising:
engaging by the distinguished thread in a execution barrier protocol with another distinguished thread of another processor device.

20. The method of claim 16 further comprising:
placing the distinguished thread in a low-power state; and
restoring the distinguished thread from the low-power state.

21. The method of claim 15 wherein the re-enabling comprises:
re-enabling by a thread re-enablement mechanism the first execution of the first program code of the first thread and the second execution of the second program code of the second thread.

22. The method of claim 15 further comprising:
applying a thread mask to specify the first thread and the second thread as being subject to the detecting and re-enabling.
